(19) United States
(12) Patent Application Publication
(10) Pub. No.: US 2015/0320066 A1
(43) Pub. Date: Nov. 12, 2015

(54) COFFEE WHITENER USING SOYBEAN EMULSION COMPOSITION

(71) Applicant: FUJI OIL COMPANY LIMITED, Osaka-shi, Osaka (JP)

(72) Inventors: Mai KANDA, Osaka (JP); Masanobu YANAGISAWA, Osaka (JP)

(73) Assignee: FUJI OIL COMPANY LIMITED, Izumisano-shi, Osaka (JP)

(21) Appl. No.: 14/648,466

(22) PCT Filed: Nov. 20, 2013
(86) PCT No.: PCT/JP2013/081243

§ 371 Date: May 29, 2015

(30) Foreign Application Priority Data
Nov. 30, 2012 (JP) 2012-263309

(51) Int. Cl. A23C 11/06

(52) U.S. Cl. CPC A23C 11/06

(57) ABSTRACT

[Problem] To provide a coffee whitener using a soybean material, said coffee whitener having a rich taste and good flavor. [Solution] A coffee whitener having a rich taste and good flavor, said coffee whitener being prepared by using, as a starting material, a soybean emulsion composition which has a protein content of 25 wt % or more on the dry basis, a lipid content (expressed in the amount of an extract obtained by using a solvent mixture consisting of chloroform and methanol) of 100 wt % or more relative to the protein content, and an LCI value of 60% or more.

### TECHNICAL FIELD

The present invention relates to a coffee whitener including a soybean emulsion composition and a process for producing the same.

### BACKGROUND ART

A coffee whitener is added to a coffee to give a mild taste to the coffee. Generally, an animal-source coffee whitener including milk as a main raw material has been used. However, in recent years, milk, which is a raw material of the animal-source coffee whitener, has problems of product shortage and radioactivity. In addition, the animal-source coffee whitener has problems for a health, such as high cholesterol content.

Therefore, in order to solve the above problems, producing a plant-source coffee whitener using a soybean material is considered. For example, Patent Document 1 discloses a coffee whitener obtained by mixing and emulsifying soymilk, plant oil, emulsifier, and salt. Further, Patent Document 2 discloses a coffee whitener including soymilk and emulsifier, where the emulsifier includes a polyglycerol fatty acid ester having 5 to 12 of the degree of polymerization of the glycerol and HLB 12. Moreover, producing a coffee whitener using a soybean protein isolate instead of the soymilk is also considered. For example, Patent Document 3 discloses a coffee whitener including soybean protein isolate, plant oil, phosphate, and emulsifier, where the emulsifier includes organic acid monoglyceride and sugar ester.

However, the above-mentioned coffee whitener including a soymilk or a soybean protein isolate has insufficient rich taste and insufficient mild taste required for a coffee whitener. In some cases, green-beany flavor peculiar to soybean may affect to the product. Therefore, it is still desired to provide a plant-source coffee whitener having a satisfactory taste.

### PRIOR ART DOCUMENTS

### Patent Documents

Patent Document 1: JP H04-9504 B
Patent Document 2: JP 2006-158295 A
Patent Document 3: JP H06-303901 A

### SUMMARY OF THE INVENTION

### Problems to be Solved by the Invention

An object of the present invention is to provide a coffee whitener having a rich and good taste while including a soybean material. Another object is to provide a coffee whitener of which the emulsion stability over a long period is maintained. Further object is to provide a coffee whitener of which feathering when the coffee whitener is added to coffee is prevented.

### Means for Solving the Problems

The present inventors have intensively studied in order to solve the above-mentioned problems. As a result, they have found that a coffee whitener having rich and good taste is made from a soybean emulsion composition as a raw material, where the soybean emulsion composition includes a protein at a content of 25 wt % or more in terms of dry basis, and a fat at a content of 100 wt % or more (determined as an extract with a chloroform/methanol mixed solvent) relative to the protein content, and where the soybean emulsion composition has an LCI value of 60% or more. The present invention has been completed on the basis of these findings.

That is, the present invention relates to: (1) a coffee whitener including a soybean emulsion composition, where the soybean emulsion composition includes a protein at a content of 25 wt % or more in terms of dry basis, and a fat at a content of 100 wt % or more (determined as an extract with a chloroform/methanol mixed solvent) relative to the protein content, and where the soybean emulsion composition has an LCI value of 60% or more, (2) the coffee whitener according to (1), including 0.3 wt % or more of the soybean emulsion composition in terms of soybean protein, (3) the coffee whitener according to (1) or (2), further including one or two or more of ingredients selected from the group consisting of fat, protein, emulsifier, salt, sugar, starch, and flavor, (4) the coffee whitener according to (3), where the fat and protein are of plant origin, (5) the coffee whitener according to (3) or (4), including, as the emulsifier, a combination of an organic acid monoglyceride and a polyglycerol fatty acid ester or a combination of an organic acid monoglyceride and a sugar ester, (6) the coffee whitener according to (5), where average HLB value of the emulsifiers is 5 or more, (7) the coffee whitener according to any of (3) to (6), including 0.1 to 5 wt % of sugar, and (8) a process of producing a coffee whitener including using a soybean emulsion composition as a raw material, where the soybean emulsion composition includes a protein at a content of 25 wt % or more in terms of dry basis, and a fat at a content of 100 wt % or more (determined as an extract with a chloroform/methanol mixed solvent) relative to the protein content, and where the soybean emulsion composition has an LCI value of 60% or more.

### Effects of the Invention

The present invention enables to provide a coffee whitener having a rich and good taste while including a soybean material. In another embodiment, the present invention enables to provide a coffee whitener of which the emulsion stability is maintained over a long period. In further embodiment, the present invention enables to provide a coffee whitener of which feathering is prevented when the coffee whitener is added to coffee.

### DESCRIPTION OF EMBODIMENTS

Hereinafter, the present invention will be explained in detail. A coffee whitener of the present invention includes “a soybean emulsion composition” as explained below. Further detail of the soybean emulsion composition is described in JP 2012-016348 A. The soybean emulsion composition will be explained below.

### <Soybean Emulsion Composition>

The soybean emulsion composition used for the coffee whitener of the present invention is derived from soybean and is an emulsion composition containing neutral lipid and polar lipid at high content, where a ratio of lipophilic proteins (alternatively, lipoxygenase protein as another index) other than glycinin and β-conglycinin is extremely high in total protein of the composition. In addition, the soybean emulsion composition has protein content of 25 wt % or more in terms of dry basis, fat content (determined as an extract with a chloroform/methanol mixed solvent) of 100 wt % or more relative to the protein content in terms of dry basis, and LCI value of 60% or more.

### (Fat)

A fat content is generally determined by ether extraction method. However, the soybean emulsion composition used in the present invention contains not only neutral lipid but also large amount of polar lipid which is hardly extracted with ether. Therefore, a fat content of the present invention is determined by extracting with a mixed solvent of chloroform and methanol at a volume ratio of 2:1 at atmospheric boiling point for 30 minutes, and calculating fat content with assuming the obtained extract as a total fat. As a solvent extraction equipment, “Soxtec” manufactured by FOSS Co. can be used. Hereinafter, the above measurement method is also called as “chloroform/methanol mixed solvent extraction method”.

The soybean emulsion composition used in the present invention has higher fat content than the value of fat content/protein content of soy flour as a raw material. Especially, the soybean emulsion composition is rich in polar lipid. Said fat is derived from soybean as a raw material.

A fat content of the soybean emulsion composition used in the present invention is 100 wt % or more, preferably 120 to 250 wt %, more preferably 120 to 200 wt % or more relative to protein content in terms of dry basis, that is, fat is more than protein. When fat content is expressed as absolute amount, although it is not indispensable condition, it is preferably 35 wt % or more, more preferably 40 wt % or more in terms of dry basis. When fiber etc. is removed from the soybean emulsion composition, fat content can be 50 wt % or more in terms of dry basis. In addition, an upper limit of the fat content is, but not limited to, preferably 75 wt % or less, more preferably 70 wt % or less.

### (Protein)

A protein content of the soybean emulsion composition used in the present invention is 25 wt % or more, preferably 30 wt % or more in terms of dry basis. In addition, an upper limit of the protein content is, but not limited to, preferably 50 wt % or less, more preferably 40 wt % or less.

Analysis of Protein Content

The protein content in the present invention is calculated by multiplying a nitrogen content measured by Kjeldahl method by a nitrogen coefficient of 6.25.

Composition Analysis of Each Component of the Protein

Each component composition of protein in the soybean emulsion composition used in the present invention can be analyzed by SDS polyacrylamide gel electrophoresis (SDS-PAGE). A hydrophobic interaction and a hydrogen bond between protein molecules and an intermolecular disulfide bond are broken by action of SDS as a surfactant and mercaptoethanol as a reductant, and thereby, the negatively charged protein molecule shows the electrophoresis distance according to peculiar molecular weight. In the result, an electrophoretic pattern peculiar to each protein is obtained. The analysis can be carried out by staining SDS gel with Coomassie brilliant blue (CBS) as a dye after the electrophoresis, and then calculating a proportion of density of band that corresponds to each protein molecule to density of band of total protein by using densitometry.

### (Lipoxygenase Protein)

One of characteristics of the soybean emulsion composition used in the present invention is containing certain amount or more of lipoxygenase protein which is not generally contained in an oil body of soybean. The soybean emulsion composition contains 4% or more, preferably 5% or more of lipoxygenase protein relative to total protein in the soybean emulsion composition. When conventional native soybean (NSI 90 or more) is used as a raw material, lipoxygenase protein is soluble and extracted to a soluble fraction after a water extraction. On the other hand, lipoxygenase protein is denatured by a heat treatment and insolubilized in the soybean raw material, and thereby remaining in an insoluble fraction. By increasing lipoxygenase protein content in total protein, emulsification state of fat is stabilized, smooth texture, which is difficult to obtain from a general soybean protein composition based on globulin protein, is obtained, and rich taste is added to the soybean composition.

Normally, there are three types of lipoxygenase protein, L-1, L-2 and L-3. A content of each lipoxygenase protein can be calculated from density of band that corresponds to each lipoxygenase protein by using the above electrophoresis.

### (Lipophilic Proteins)

One of characteristics of the soybean emulsion composition used in the present invention is containing lipophilic proteins among several kind of protein at higher content as compared with conventional soybean composition. The lipophilic proteins refer to a group of minor acid-precipitable soybean proteins other than glycinin (7S globulin) and β-conglycinin (11S globulin) among acid-precipitable soybean proteins of a soybean, and are accompanied by a lot of polar lipids such as lecithin and glycolipid. Hereinafter, the lipophilic proteins are simply abbreviated as “LP” in some cases. Since LP is a mixture of various proteins, it is difficult to specify all of respective proteins and LP content. However, LP content can be estimated by determining the following LCI (Lipophilic Proteins Content Index) value. LCI value of protein in the soybean emulsion composition is usually 60% or more, preferably 63% or more, more preferably 65% or more. When conventional native soybean (NSI 90 or more) is used as a raw material, LP is soluble and extracted to a soluble fraction after a water extraction. On the other hand, in the case of the soybean emulsion composition used in the present invention, LP is denatured by a heat treatment and insolubilized in the soybean raw material, and thereby remaining in an insoluble fraction. By increasing LP content in total protein, emulsification state of fat is stabilized, smooth texture which is difficult to obtain from a general soybean protein composition based on globulin protein is obtained, and rich taste is added to the soybean composition.

### [Method of Estimating LP Content and Measuring LCI Value]

(a) As the main proteins in respective proteins, an α subunit and an α′ subunit (α+α′) are selected for 7S, an acidic subunit (AS) is selected for 11S, and a 34 kDa protein and lipoxygenase (P34+Lx) are selected for LP. Then, a staining ratio among the selected proteins on SDS-PAGE is determined. Electrophoresis can be performed under the condition shown in Table 1. (b) X (%)=(P34+Lx)/{(P34+Lx)+(α+α′)+AS}×100(%) is calculated. (c) Since the LP content of an isolated soybean protein prepared from a low-denatured defatted soybean is about 38% as measured by the fractionation methods of the above described Methods 1 and 2 before heat-sterilization, (P34+Lx) is multiplied by a correction coefficient k*=6 so that X becomes 38(%). (d) That is, an estimated LP content (Lipophilic Proteins Content Index, hereinafter abbreviated as “LCI”) is calculated by the equation below.

TABLE 1

| | |
|---|---|
| Application amount: | 10 μl of a protein 0.1% sample |
| | solution per well |
| Well width: | 5 mm |
| Well volume: | 30 μl |
| Staining solution: | Coomassie Brilliant Blue (CBB) 1 g, |
| | methanol 500 ml, glacial acetic acid |
| | 70 ml (after CBB is completely |
| | dissolved in methanol, acetic acid |
| | and water are added to 1 L) |
| Staining time: | 15 hours |
| Discoloration time: | 6 hours |
| Densitometer: | GS-710 Calibrated Imaging |
| | Densitometer/Quantity One Software |
| | Ver.4.2.3 (Bio Rad Japan Co. Ltd) |
| | Scanning width: 5.3 mm, |
| | Sensitivity: 30 |

$$LCI ( \% ) = \frac{{k}^{*} \times ( P 34 + Lx )}{{k}^{*} \times ( P 34 + Lx ) + ( α + {α}^{′} ) + AS} \times 100$$

K*: Correction coefficient (6)
P34: LP main component, 34 kDa protein
Lx: LP main component, lipoxygenase
α: 7S main component, α subunit
α′: 7S main component, α′ subunit
AS: 11S main component, acidic subunit

### (Dry Matter)

Generally, a form of the soybean emulsion composition used in the present invention is similar to that of fresh cream. Dry matter in the soybean emulsion composition is usually, but not limited to, around 20 to 30 wt %. For example, the soybean emulsion composition can be a liquid form with low viscosity obtained by adding water, a cream form with high viscosity obtained by condensation and a powder form obtained by powderization.

### (Aspect of Producing the Soybean Emulsion Composition)

The soybean emulsion composition used in the present invention can be obtained by adding water to a fat-containing soybean which contains a fat at a content of 15 wt % or more in terms of dry basis and which has Nitrogen Solubility Index (hereinafter, refers to “NSI”) in the range from 20 to 77, preferably from 20 to 70, to prepare a suspension liquid, and then subjecting the suspension liquid to a solid-liquid separation to transfer neutral lipid and polar lipid to an insoluble fraction, and then removing a soluble fraction including protein and sugar, and then recovering the insoluble fraction. Hereinafter, an aspect of the production method will be explained.

### Soybean Raw Material and Processing Thereof

A fat-containing soybean such as whole fat soybean and partially defatted soybean is used as a soybean raw material for producing the soybean emulsion composition. The partially defatted soybean includes one obtained by subjecting whole fat soybean to a physical extraction treatment such as press extraction for partially defatting. Generally, whole fat soybean contains about 20 to 30 wt % of fat in terms of dry basis. There are also special soybeans which contain 30 wt % or more of fat. The fat-containing soybean used for the present invention is not particularly limited, but soybean having 15 wt % or more, preferably 20 wt % or more of fat is preferable. A form of the raw material can include halved, grits or powder form.

When fat content is too low because of too much defatting, it is difficult to obtain the soybean emulsion composition of the present invention rich in fat. Especially, defatted soybean having 1 wt % or less of neutral lipid content obtained by solvent extraction such as hexane extraction is not preferable because good soybean taste is deteriorated.

Generally, the above described fat-containing soybean is soluble and has 90 or more of NSI because most of the constituent proteins are nature. However, a modified soybean, which is subjected to a process so that NSI of the modified soybean is 20 to 77, preferably 20 to 70, is preferably used. A lower limit of the NSI is more preferably 40 or more, further preferably 41 or more, further more preferably 43 or more, most preferably 45 or more. An upper limit of the NSI is more preferably less than 75, further preferably less than 70. In addition, soybean having low NSI such as less than 65, less than 60 and less than 58 can be used.

Such a modified soybean is obtained by carrying out a processing treatment such as heat treatment and alcohol treatment. The processing treatment includes, but not limited to, heat treatment such as dry heat treatment, steam treatment, superheated steam treatment and microwave treatment, hydrous ethanol treatment, high-pressure treatment and combination thereof.

When NSI is too low, protein ratio in the soybean emulsion composition tends to be high, that is, fat content relative to protein content becomes low. In addition, unpleasant taste such as roast flavor tends to be added. On the other hand, when NSI is high value such as 80 or more, protein ratio in the soybean emulsion composition is low and fat recovery rate from soybean also tends to be low. In addition, as for the taste, green-beany flavor becomes strong.

When heat treatment with superheated steam is carried out, treatment condition cannot be specified for all cases since it will differ depending on manufacturing environment, but appropriate condition for obtaining a modified soybean having the above range of NSI can be determined without special difficulty, for example, heating with superheated steam at about 120 to 250° C. for 5 to 10 minutes. As simple means, commercially available soybean having the above range of NSI can be used.

NSI can be expressed as ratio (wt %) of water-soluble nitrogen (crude protein) to total nitrogen and determined by a prescribed method. In the present invention, NSI is determined by the following method.

To 2.0 g of sample is added 100 ml of water. The mixture is stirred at 40° C. for 60 minutes, and then centrifuged at 1400×g for 10 minutes to obtain supernatant 1. To the residual precipitate is added 100 ml of water. The mixture is stirred at 40° C. for 60 minutes, and then centrifuged at 1400×g for 10 minutes to obtain supernatant 2. The supernatant 1 and supernatant 2 are combined, and water is added to 250 ml. After filtering the mixture with No. 5A filter paper, nitrogen in the filtrate is determined by Kjeldahl method. At the same time, nitrogen in the sample is determined by Kjeldahl method. NSI is the ratio of nitrogen in the filtrate (soluble nitrogen) to total nitrogen in the sample, and expressed as wt %.

The above modified soybean is preferably subjected to a dry or wet tissue destruction treatment such as grinding, crushing and depressing before a water extraction. The soybean can be swelled by water immersion or steaming before the tissue destruction treatment. By the swelling, the amount of energy required to the tissue destruction can be reduced and component having unpleasant taste such as whey protein and oligosaccharide can be eluted and removed, as well as, extraction ratio of globulin protein (in particular, glycinin and β-conglycinin) having high water retention ability and gelling ability to total protein can be increased, that is, transfer ratio of the globulin protein into the soluble fraction can be increased.

Water Extraction from Soybean Raw Material

Water extraction is carried out by adding water at about 3 to 20 times by weight, preferably 4 to 15 times by weight relative to an amount of fat-containing soybean, and thereby preparing a suspension of the fat-containing soybean. When adding ratio of water is high, extraction rate of water-soluble component is high and good separation can be obtained. However, when the adding ratio is too high, a concentration is necessary and thereby increasing in cost. In addition, when water extraction is repeated twice or more, extraction rate of water-soluble component can be improved.

An extraction temperature is not particularly limited. When the temperature is high, an extraction rate of water-soluble component can be improved, but fat also tends to be soluble, and thereby, fat content in the soybean emulsion composition becomes low. Therefore, the extraction temperature is preferably 70° C. or lower, more preferably 55° C. or lower. Alternatively, the water extraction can be carried out at 5 to 80° C., more preferably 50 to 75° C.

Concerning an extraction pH (pH of a soybean suspension after adding water), as is the case in the extraction temperature, when the pH is high, an extraction rate of water-soluble component can be improved, but fat also tends to be soluble, and thereby, fat content in the soybean emulsion composition becomes low. On the other hand, when the pH is too low, an extraction rate of protein tends to be low. More specifically, the extraction can be carried out with adjusting a lower limit of pH to pH 6 or higher, pH 6.3 or higher, or pH 6.5 or higher. In addition, the extraction can be carried out with adjusting an upper limit of pH to pH 9 or lower, pH 8 or lower, or pH 7 or lower from a standpoint of increasing a separation efficiency of fat. Alternatively, the extraction can be carried out with adjusting pH to more alkaline, pH 9 to 12 from a standpoint of increasing an extraction rate of protein.

Solid-Liquid Separation after the Water Extraction

After the water extraction, the suspension of the fat-containing soybean is subjected to a solid-liquid separation such as centrifugation and filtration. In this case, it is important that most of fat including neutral lipid as well as polar lipid is not eluted to water-extract, but transferred to a fraction of insolubilized protein and fiber as a precipitate (insoluble fraction). More specifically, 70 wt % or more of fat of fat-containing soybean is transferred to the precipitate. In addition, a small amount of fat is eluted to a supernatant when carrying out the extraction. However, it is different from a fat which is finely emulsified in soymilk, and can easily be floated and separated by centrifuging at 15,000×g or less or about 5,000×g or less. In this respect, it is preferable to use a centrifuge. In addition, an ultracentrifuge at 100 thousand×g or more can be used depending on facilities. However, in the case of this soybean emulsion composition used in the present invention, it can be carried out without using the ultracentrifuge.

In addition, demulsifier can be added during or after the water extraction to improve fat separation from soymilk. The demulsifier is not particularly limited. For example, a demulsifier described in Patent Document 2 described in U.S. Pat. No. 6,548,102 can be used. Further, the present invention can be carried out without using the demulsifier.

Not only neutral lipid but also polar lipid can be transferred to an insoluble fraction by the solid-liquid separation after the water extraction. A fraction of this soybean emulsion composition can be obtained by recovering the insoluble fraction. In the case of using centrifugation as solid-liquid separation, any separation system such as two phase separation system and three phase separation system can be used. In the case of using the two phase separation system, an insoluble fraction as precipitate layer is recovered. In the case of using the three phase separation system, it can be separated to three fractions, (1) floating layer (cream fraction with lowest specific weight including fat), (2) mid layer (water-soluble fraction including a small amount of fat and large amounts of protein and sugar) and (3) precipitate layer (insoluble fraction including large amounts of fat and fiber). In this case, soluble fraction, mid layer (2) having a small amount of fat is removed or recovered aside, and floating layer (1) or precipitate layer (3) is recovered. Alternatively, both floating layer (1) and precipitate layer (3) are recovered as the insoluble fraction.

The obtained insoluble fraction (1) and (3) can be the soybean emulsion composition as is, or after subjecting to concentration step, heat pasteurization step and powderization step as necessary.

### Removal of Fiber

When the obtained insoluble fraction includes fiber, for example, the above fraction (3) or fractions (1) and (3), as necessary, a soybean emulsion composition in which fiber (okara) is removed and rich taste is more concentrated can be obtained by adding water to the fraction, homogenizing the solution with a high-pressure homogenizer or a Jet Cooker Heater, and then centrifuging the homogenized liquid to recover a supernatant. As necessary, an additional step such as heat treatment step and alkaline treatment step can be carried out before or after the homogenization to make protein extraction easier. In this case, fiber content is preferably 10 wt % or less, more preferably 5 wt % or less in terms of dry basis. Fiber content in the present invention can be determined by enzymatic-gravimetric method (Modified Prosky Method) based on “STANDARD TABLES OF FOOD COMPOSITION IN JAPAN Fifth Revised and Enlarged Edition” (Ministry of Education, Culture, Sports, Science and Technology, Japan, 2005).

### (Feature of the Soybean Emulsion Composition)

The above soybean emulsion composition used in the present invention contains a specific range of fat (neutral lipid and polar lipid) and protein. Among the protein, especially LP content is high. The soybean emulsion composition optionally contains fiber. In addition, the soybean emulsion composition has concentrated delicious natural taste of soybean, very rich taste and no or little unpleasant taste such as green-beany flavor, astringency and harsh taste.

Although an emulsion composition (assembled product) having similar components as the soybean emulsion composition can be prepared by adding water and fat to conventional soy flour or soybean protein isolate, it is difficult to prepare the composition having similar lipoxygenase protein content and LCI value. The soybean emulsion composition obtained by the technique has much better taste than the assembled product. Therefore, the soybean emulsion composition has good aptitude for a food raw material.

An additive amount of the soybean emulsion composition in terms of amount of soybean protein in the coffee whitener is preferably 0.3 wt % or more, preferably 0.3 to 5.0 wt %. Examples of the preferred additive amount of the soybean emulsion composition in terms of amount of soybean protein in the coffee whitener include 0.3 to 3.0 wt %, 0.5 to 2.5 wt %, 0.5 to 2.0 wt % and 1.5 to 2.0 wt %.

A protein content in the coffee whitener is preferably 0.3 to 5.0 wt %, more preferably 0.3 to 3.0 wt %, further preferably 0.5 to 2.5 wt %. When the protein content in the coffee whitener is too low, an emulsion stability of the coffee whitener may decrease and viscosity may considerably increase to form solidification state (“bote” state). In addition, when the protein content in the coffee whitener is too high, the coffee whitener may not be uniformly dispersed and may form aggregation substance (feathering) in the coffee after adding the coffee whitener to the coffee. All of the protein in the coffee whitener of the present invention may be derived from the soybean emulsion composition. Alternatively, other protein such as skim milk powder may be added. From the viewpoint of health, all of the protein may preferably be plant origin, soybean protein.

### (Emulsifier)

An emulsifier used in the coffee whitener of the present invention is not particularly limited. Examples of the emulsifier include organic acid monoglyceride, sugar ester, propylene glycol fatty acid ester, glycerol fatty acid ester, polyglycerol fatty acid ester, sorbitan fatty acid ester, lecithin and enzyme-decomposed lecithin. The emulsifier may be used alone or in combination of two or more of emulsifiers. Among them, a combination of organic acid monoglyceride and polyglycerol fatty acid ester or a combination of organic acid monoglyceride and sugar ester is preferable, and a combination of organic acid monoglyceride and polyglycerol fatty acid ester is more preferable.

An additive amount of the emulsifier in the coffee whitener is preferably 0.4 to 1.5 wt %. When the additive amount of the emulsifier is less than 0.4 wt %, the emulsion stability of the coffee whitener may decrease. In this case, the coffee whitener may not be uniformly dispersed and may form feathering in the coffee after the coffee whitener is added to the coffee. Even when the additive amount of the emulsifier is more than 1.5 wt %, a function of the coffee whitener may not be improved any more. An average HLB value of the emulsifier is preferably more than 4, preferably 5 to 16, more preferably 5 to 14, further preferably 10 to 13.

### (Fat)

All of the fat in the coffee whitener of the present invention may be derived from the soybean emulsion composition. Or, other fats may be added to the coffee whitener. Any fats can be added to the coffee whitener as long as the fat is edible. Examples of the fat include plant oil such as corn oil, soybean oil, sesame oil, rice bran oil, safflower oil, cottonseed oil, sunflower oil, rapeseed oil, coconut oil, palm oil, palm kernel oil, olive oil, peanut oil, almond oil, avocado oil, hazelnut oil, walnut oil and perilla oil; and animal oil such as milk fat, beef tallow, lard, whale oil, fish oil and chicken oil. It is preferable to use plant oil because it is easy to control the physical property of the fat and a plant-source coffee whitener, all ingredients of which are plant origin, can be prepared. Single fat or any combinations of two or more fats, processed fat such as hydrogenated, fractionated or interesterified fat thereof may also be used.

A fat content in the coffee whitener of the present invention is preferably 10 to 40 wt %. When the fat content is less than 10 wt %, the coffee whitener may not be uniformly dispersed after added to coffee. When the fat content is more than 40 wt %, an emulsion stability of the coffee whitener may decrease.

### (Phosphate)

Phosphorus such as phosphoric acid and phosphate may be added to the coffee whitener of the present invention. The phosphoric acid and phosphate, which can be used, are not particularly limited as long as these are edible. Examples of the available phosphoric acid and phosphate include hexametaphosphate, disodium hydrogen phosphate, dipotassium hydrogen phosphate, sodium dihydrogen phosphate, potassium dihydrogen phosphate, trisodium phosphate, tripotassium phosphate, sodium polyphosphate, and phytate.

By using phosphate, it is possible to achieve an improvement of dispersion and further suppression of formation of feathering. When using phosphate, the additive amount in the coffee whitener is preferably 0.2 to 1.5 wt %. When the additive amount of phosphate is less than 0.2 wt %, the effect by adding phosphate is hardly obtained. When the additive amount of phosphate is more than 1.5 wt %, taste peculiar to phosphate may be added to coffee and the taste of coffee may become worse after the coffee whitener is added to the coffee.

### (Sugar)

One or two or more of sugars may be added to the coffee whitener of the present invention. The sugar, which can be added, is not particularly limited. Examples of the sugar include glucose, fructose, sucrose, maltose, enzyme-saccharified syrup, lactose, hydrogenated starch hydrolysate, isomerized liquid sugar, sucrose-coupling syrup, oligosaccharides, reducing sugar polydextrose, sorbitol, reduced lactose, trehalose, xylose, xylitol, maltitol, erythritol, mannitol, fructooligosaccharides, soybean oligosaccharides, galactooligosaccharides, lactosucrose oligosaccharides, raffinose, lactulose, palatinose oligosaccharides, stevia, aspartame, sugar alcohol.

Adding the sugar may provide further storage stability to the coffee whitener. An additive amount of the sugar is preferably 0.1 to 5 wt %, preferably 0.1 to 3 wt %, more preferably 0.5 to 2.5 wt %, and further preferably 1.5 to 2.5 wt %.

### (Starch)

One or two or more of starches may be added to the coffee whitener of the present invention. The starch, which can be added, is not particularly limited. Examples of the available starch include corn starch, waxy corn starch, wheat starch, rice starch, potato starch, tapioca starch, sweet potato starch, sago starch, and modified starch thereof. Examples of the available modified starch include oxidized starch, acid treated starch, enzyme-treated starch, starch acetate, starch phosphate, starch succinate, starch octenylsuccinate, hydroxypropyl starch, cross-linked starch, and moist heat-treated starch.

### (Other Raw Materials)

Raw materials, which are generally used to a coffee whitener, may be added to the coffee whitener of the present invention. For example, one or two or more of raw materials selected from dairy product such as fresh cream; flavor; colorant; sweetener such as aspartame, acesulfame potassium and sucralose; stabilizer such as sodium caseinate; and polysaccharide such as carrageenan and gellan gum, may be added.

### (Production Process)

Hereinafter, a typical production process of a plant-source coffee whitener will be explained. First, phosphate is dissolved into water while heating at 60 to 70° C. To the obtained solution, soybean material and emulsifier are added while stirring to dissolve or disperse. Then, plant oil is added to the solution, and then the mixture is pre-emulsified. After the pre-emulsification, the mixture is homogenized with a homogenizer, and then sterilized by batch sterilization or UHT sterilization with an indirect heating or direct heating. After the sterilization, the mixture is again homogenized with a homogenizer and cooled.

The coffee whitener of the present invention can be prepared by the above described typical production process, or can also be prepared by other process known to a skilled person in the art.

### (Coffee Whitener)

The coffee whitener of the present invention can also be distributed, for example, with a container in which the coffee whitener is filled. This embodiment has the advantages of an ease of storage and transportation and readily available because the composition can be heat sterilized and aseptically filled. As the filling process, a process including heat-sterilizing the coffee whitener and then filling to container under an aseptic condition (for example, a combination of UHT sterilization and aseptic filling), or a process including filling the coffee whitener into a container and then heat-sterilizing the coffee whitener together with the container (for example, retort sterilization) can be carried out. The UHT sterilization process can be either an indirect heating process or a direct heating process. In addition, the coffee whitener of the present invention may be prepared and distributed as a dried powder after subjecting a process such as spray drying. And the powder may be directly added into a coffee. Alternatively, the dried powder may be reconstituted to liquid coffee whitener with water immediately before use.

### EXAMPLES

The present invention will be described in more detail below by way of examples of the present invention, but the spirit of the present invention is not limited by the following examples. In the examples, both of % and part mean a weight basis unless otherwise stated.

### Preparation of a Soybean Emulsion Composition

### Production Example 1

According to the disclosure of Example 1 of JP 2012-016348 A, a soybean emulsion composition was prepared. The obtained soybean emulsion composition had 30.6% of dry matter, 32.2% and 43.0% of protein content and fat content in terms of dry basis, respectively, and 67% of LCI.

### Comparison to Soymilk

### Example 1 and Comparative Example 1

Into 58 parts by weight of water, 0.4 part by weight of dipotassium phosphate was dissolved while heating at 60 to 70° C. To the solution, 27.9 parts by weight of the soybean emulsion composition (Example 1) or 31.9 parts by weight of plain soymilk (manufactured by Fuji Oil Co., Ltd., Comparative Example 1), 0.44 part of diacetyl-tartaric acid fatty acid ester as organic acid monoglyceride (Sunsoft 641D, Taiyo Kagaku Co., Ltd.) and 0.7 part of polyglycerol fatty acid ester (RYOTO Polyglycerol Ester M-10D, Mitsubishi-Kagaku Foods Corporation, average FILE: 12.7) were added and stirred. After dissolving or dispersing the soybean emulsion composition or soymilk, and emulsifier, 22 parts by weight of palm kernel oil was added to the solution, and then subjecting the mixture to pre-emulsification. After the pre-emulsification, the mixture was homogenized with a homogenizer at 30 to 150 kgf/cm², and then sterilized with indirect heating apparatus (Manufactured by Powerpoint International Co.) at 140° C. for 30 seconds. After the sterilization, the mixture was homogenized with a homogenizer at 30 to 150 kgf/cm², and then cooled to obtain coffee whiteners of Example and Comparative Example.

### Comparison of Various Emulsifiers

### Examples 2 to 8

Coffee whiteners were prepared in the same manner as Example 1 except that additive amount of the soybean emulsion composition and the kind of emulsifier were changed according to table 2 (Examples 2 to 8). In these Examples, Sunsoft 641D was used as diacetyl-tartaric acid fatty acid ester and Sunsoft 683CB was used as succinic acid monooleate (both are manufactured by Taiyo Kagaku Co., Ltd.). RYOTO Polyglycerol Ester M-7D, RYOTO Polyglycerol Ester M-10D, RYOTO Polyglycerol Ester SWA-10D or RYOTO Polyglycerol Ester B-100D (manufactured by Mitsubishi-Kagaku Foods Corporation) was used as polyglycerol fatty acid ester. DK ester F160 (manufactured by DKS Co. Ltd.) or RYOTO Sugar Ester S-170 (manufactured by Mitsubishi-Kagaku Foods Corporation) was used as sugar ester.

Each of the coffee whiteners obtained by the above described process was added to commercially available coffee (pH: 5.02), and the taste and the condition of dispersion (feathering) were evaluated. In addition, the stability after chilled storage was evaluated. These results were shown in table 2.

The taste of each of the coffee whiteners was evaluated by giving 1 to 5 points as an overall evaluation of green-beany flavor and rich taste, and 3 points or more was acceptable. The feathering of each of the coffee whiteners was evaluated according to the following basis: a case that aggregation was observed in coffee was assumed to be 5 points, a case that a lot of feathering was observed in coffee was assumed to 4 points, a case that feathering was observed in coffee was assumed to 3 points, a case that feathering was slightly observed in coffee was assumed to 2 points, a case of good that feathering was not observed was assumed to 1 point. The emulsion stability was evaluated after storing each of the coffee whiteners at 5° C. for 1 week from the viewpoint of change of viscosity: a case that bote state was not observed was assumed to be 1 point, a case that bote state was slightly observed was assumed to 2 points, a case that bote state was observed was assumed to 3 points.

TABLE 2
Comparison of soymilk and various emulsifiers

| | | | | | | | | | | | Comparative |
|---|---|---|---|---|---|---|---|---|---|---|---|
| | | | Example | | | | | | | | Example |
| | | HLB | 1 | 2 | 3 | 4 | 5 | 6 | 7 | 8 | 1 |
| | | | Protein content (%) | | | | | | | | |
| Plain | | | | | | | | | | | 1.5 |
| soymilk | | | | | | | | | | | |
| Soybean | | | 1.5 | 0.5 | 1.5 | 1.5 | 1.5 | 1.5 | 1.5 | 2.0 | |
| emulsion | | | | | | | | | | | |
| composition | | | | | | | | | | | |
| | | | Formulation (%) | | | | | | | | |
| Diacetyl- | Sunsoft | 9 | 0.44 | 0.44 | 0.44 | 0.44 | 0.44 | 0.44 | | 0.53 | 0.44 |
| tartaric acid | 641D | | | | | | | | | | |
| fatty acid | | | | | | | | | | | |
| ester | | | | | | | | | | | |
| Succinic acid | Sunsoft | 8.5 | | | | | | | 0.44 | | |
| monooleate | 683CB | | | | | | | | | | |
| Polyglycerol | RYOTO | 16 | | | 0.70 | | | | | | |
| fatty acid | Polyglycerol | | | | | | | | | | |
| ester | Ester M-7D | | | | | | | | | | |
| Polyglycerol | RYOTO | 15 | 0.70 | 0.70 | | | | | | 0.84 | 0.70 |
| fatty acid | Polyglycerol | | | | | | | | | | |
| ester | Ester M-10D | | | | | | | | | | |
| Polyglycerol | RYOTO | 14 | | | | 0.70 | | | | | |
| fatty acid | Polyglycerol | | | | | | | | | | |
| ester | Ester SWA-10D | | | | | | | | | | |
| Polyglycerol | RYOTO | 3 | | | | | 0.70 | | | | |
| fatty acid | Polyglycerol | | | | | | | | | | |
| ester | Ester B-100D | | | | | | | | | | |
| Sugar ester | DK ester F160 | 15 | | | | | | | 0.70 | | |
| Sugar ester | RYOTO Sugar | 1 | | | | | | 0.70 | | | |
| | Ester S-170 | | | | | | | | | | |
| | | Average | 12.7 | 12.7 | 13.3 | 12.1 | 5.3 | 4.1 | 12.5 | 12.7 | 12.7 |
| | | HLB | | | | | | | | | |
| | | Feathering | 1 | 1 | 1 | 1 | 1 | 1 | 1 | 1 | 2 |
| | | Emulsion | 1 | 1 | 2 | 2 | 2 | 2 | 2 | 1 | 1 |
| | | stability | | | | | | | | | |
| | | Taste | 4 *1 | 3 *2 | 4 *1 | 4 *1 | 4 *1 | 4 *1 | 4 *1 | 5 *3 | 1 *4 |

*1: Richer taste than Example 2 and no green-beany flavor of soybean were felt, and a good coffee taste was preserved.
*2: No green-beany flavor of soybean was felt, and a good coffee taste was preserved.
*3: Richer taste than Examples 1-7 and no green-beany flavor of soybean were felt, and a good coffee taste was preserved.
*4: No rich taste, weak taste and insufficient mild taste were felt.

Example 1 showed good taste having rich and mild taste when added to coffee. In contrast, Comparative Example 1 did not show rich and deep taste, and sufficient mild taste. In addition, feathering was not observed when the coffee whitener of Example 1 was added to coffee immediately after the production and after the storage at 5° C. for 1 week. Example 1 showed good emulsion stability. In Comparative Example 1, feathering was slightly observed when the coffee whitener was added to coffee after the storage at 5° C. for 1 week. As shown in the above, it was confirmed that coffee whitener having rich and good taste was obtained by using the soybean emulsion composition.

Example 2 in which the soybean emulsion composition was formulated so that the protein content in the coffee whitener was 0.5%, Examples 3 to 5 of which the average HLB was adjusted by the combination of organic acid monoglyceride and polyglycerol fatty acid ester, Examples and 7 in which organic acid monoglyceride and sugar ester were formulated together, and Example 8 in which the soybean emulsion composition was formulated so that the protein content in the coffee whitener was 2.0% were evaluated. Examples 2 to 7 had a rich taste, and Example 8 had richer taste than Example 1. All of the Examples 2 to 8 showed no green-beany flavor and good flavor, and preserved good coffee flavor. Examples 3 to 7 tended to slightly increase the viscosity after the storage at 5° C. for 1 week, but were acceptable. Examples 2 and 8 showed good emulsion stability. In Examples 2 to 5, 7 and 8, feathering was hardly observed. From the above, it was confirmed that coffee whitener having rich and good taste and good emulsion stability can be prepared by using the soybean emulsion composition regardless of the emulsifier. In addition, the emulsifier having 5 or more of average HLB showed good results for feathering. From the viewpoint of emulsion stability and feathering, a combination of organic acid monoglyceride and polyglycerol fatty acid ester having about 12.7 of average HLB showed best result.

Comparison of Addition of Sugar

Coffee whiteners were prepared in the same manner as Example 1 except that 2.0 parts of granulated sugar (Example 9), refined sugar (Example 10) or maltose (Example 11) was added. The emulsion stability and feathering of each of coffee whiteners of Examples 1, 9 to 11 were evaluated according to the above explained evaluation criteria after storing at 5° C. for 2 months. As a result, feathering was prevented even after the long storage in the group of adding sugar. Result are shown in table 3

TABLE 3
Study of stability by adding sugar

| | | | Example | | | |
|---|---|---|---|---|---|---|
| | | HLB | 1 | 9 | 10 | 11 |
| | | | (Protein content %) | | | |
| Plain | | | | | | |
| soymilk | | | | | | |
| Soybean | | | 1.5 | 1.5 | 1.5 | 1.5 |
| emulsion | | | | | | |
| composition | | | | | | |
| | | | (Formulation %) | | | |
| Diacetyl- | Sunsoft | 9 | 0.44 | 0.44 | 0.44 | 0.44 |
| tartaric acid | 641D | | | | | |
| fatty acid | | | | | | |
| ester | | | | | | |
| Polyglycerol | RYOTO | 15 | 0.70 | 0.70 | 0.70 | 0.70 |
| fatty acid | Polyglycerol | | | | | |
| ester | Ester M-10D | | | | | |
| | Granulated | | | 2.00 | | |
| | sugar | | | | | |
| | Refined sugar | | | | 2.00 | |
| | Maltose | | | | | 2.00 |
| | | Average | 12.7 | 12.7 | 12.7 | 12.7 |
| | | HLB | | | | |
| | | Feathering | 3 | 1 | 1 | 1 |
| | | Emulsion | 1 | 1 | 1 | 1 |
| | | stability | | | | |

### INDUSTRIAL APPLICABILITY

As above-mentioned, a coffee whitener having rich taste, no green-beany flavor, and good taste as compared with a conventional coffee whitener made from soymilk or soybean protein isolate is prepared by adding the soybean emulsion composition.

1. A coffee whitener comprising a soybean emulsion composition, wherein the soybean emulsion composition comprises a protein at a content of 25 wt % or more in terms of dry basis, and a fat at a content of 100 wt % or more (determined as an extract with a chloroform/methanol mixed solvent) relative to the protein content, and wherein the soybean emulsion composition has an LCI value of 60% or more.

2. The coffee whitener according to claim 1, comprising 0.3 wt % or more of the soybean emulsion composition in terms of soybean protein.

3. The coffee whitener according to claim 1, further comprising one or two or more of ingredients selected from the group consisting of fat, protein, emulsifier, salt, sugar, starch, and flavor.

4. The coffee whitener according to claim 3, wherein the fat and protein are of plant origin.

5. The coffee whitener according to claim 3, comprising, as the emulsifier, a combination of an organic acid monoglyceride and a polyglycerol fatty acid ester or a combination of an organic acid monoglyceride and a sugar ester.

6. The coffee whitener according to claim 5, wherein average HLB value of the emulsifiers is 5 or more.

7. The coffee whitener according to claim 3, comprising 0.1 to 5 wt % of sugar.

8. A process of producing a coffee whitener comprising using a soybean emulsion composition as a raw material, wherein the soybean emulsion composition comprises a protein at a content of 25 wt % or more in terms of dry basis, and a fat at a content of 100 wt % or more (determined as an extract with a chloroform/methanol mixed solvent) relative to the protein content, and wherein the soybean emulsion composition has an LCI value of 60% or more.

9. The coffee whitener according to claim 2, further comprising one or two or more of ingredients selected from the group consisting of fat, protein, emulsifier, salt, sugar, starch, and flavor.

10. The coffee whitener according to claim 4, comprising, as the emulsifier, a combination of an organic acid monoglyceride and a polyglycerol fatty acid ester or a combination of an organic acid monoglyceride and a sugar ester.

11. The coffee whitener according to claim 4, comprising 0.1 to 5 wt % of sugar.

12. The coffee whitener according to claim 5, comprising 0.1 to 5 wt % of sugar.

13. The coffee whitener according to claim 6, comprising 0.1 to 5 wt % of sugar.
